(19) United States
(12) Patent Application Publication
(10) Pub. No.: US 2026/0252885 A1
(43) Pub. Date: Aug. 27, 2026

(54) INFORMATION PROCESSING APPARATUS, INFORMATION PROCESSING METHOD, AND COMPUTER READABLE RECORDING MEDIUM

(71) Applicant: NEC Corporation, Minato-ku, Tokyo (JP)

(72) Inventor: Yuki KOBAYASHI, Tokyo (JP)

(73) Assignee: NEC Corporation, Minato-ku, Tokyo (JP)

(21) Appl. No.: 18/871,184

(22) PCT Filed: Jun. 20, 2022
(86) PCT No.: PCT/JP2022/024569

§ 371 Date: Dec. 3, 2024

(51) Int. Cl. G06N 3/082

(52) U.S. Cl. CPC G06N 3/082

(57) ABSTRACT

An information processing apparatus includes: a score calculation unit that inputs training data included in a training dataset to a trained neural network model, generates statistical information indicating an internal state of the trained neural network model for each piece of the training data, and calculates a score indicating a complexity of the training data based on the generated statistical information; and a parameter determination unit that determines, based on the calculated score, a parameter indicating a structure of a neural network model.

### TECHNICAL FIELD

The present disclosure relates to an information processing apparatus, an information processing method, and a computer readable recording medium for searching for a neural network structure.

### BACKGROUND ART

Conventionally, the search for a neural network structure that has high recognition accuracy and can execute recognition processing at high speed has been manually carried out by skilled Artificial Intelligence (AI) researchers and the like; however, in recent years, methods have been proposed for automatically searching for a neural network structure as described above using Neural Architecture Search (NAS) and the like.

However, the space in which the search for a neural network structure is performed (a collection of structures to be evaluated) is large, and, moreover, training needs to be repeated during the search in order to evaluate the recognition accuracy of neural networks.

Furthermore, because a single training session takes several hours to several days at present and training needs to be repeated several tens of times during the search, the calculation cost and search time required for the search are enormous.

As a related technique, Non-Patent Document 1 discloses a technique in which reinforcement learning is used to search for neural network structures having higher recognition accuracy than manually created neural network structures.

Furthermore, as a related technique, Non-Patent Document 2 discloses a technique in which a search is performed, without using reinforcement learning, by continuously relaxing the search problem and making the search problem differentiable.

Also, as a related technique, Non-Patent Document 3 discloses a technique in which a neural network structure that has high recognition accuracy and can execute recognition processing at high speed is derived by combining hardware-efficient neural network structure components by applying a bottom-up approach.

### LIST OF RELATED ART DOCUMENTS

### Non-Patent Document

[Non-Patent Document 1] Barret Zoph and Quoc V. Le, “Neural Architecture Search with Reinforcement Learning”, [online], [Submitted on 5 Nov. 2016 (v1), last revised 15 Feb. 2017 (this version, v2)], [retrieved on 16 May 2022], Internet <URL: https://arxiv.org/abs/1611.01578>
[Non-Patent Document 2] Hanxiao Liu, et al., “DARTS: Differentiable Architecture Search”, [online], [Submitted on 24 Jun. 2018 (v1), last revised 23 Apr. 2019 (this version, v2)], [retrieved on 16 May 2022], Internet <URL: https://arxiv.org/abs/1806.09055>
[Non-Patent Document 3] Xiaofan Zhang, et al., “SkyNet: a Hardware-Efficient Method for Object Detection and Tracking on Embedded Systems”, [online], [Submitted on 20 Sep. 2019 (v1), last revised 29 Feb. 2020 (this version, v2)], [retrieved on 16 May 2022], Internet <URL: https://arxiv.org/abs/1909.09709>

### SUMMARY OF INVENTION

### Problems to be Solved by the Invention

However, in Non-Patent Document 1, the calculation cost involved in the search is enormous because a vast number of Graphics Processing Units (GPUs) are used and operated over a long period of time during the search.

Furthermore, in Non-Patent Documents 2 and 3, it is difficult to conduct the search in a short time because training is repeated several times or more.

An example object of the present disclosure is to determine a parameter indicating a structure of a neural network that has high recognition accuracy and can execute recognition processing at high speed.

### Means for Solving the Problems

In order to achieve the example object described above, an information processing apparatus according to an example aspect of the present disclosure includes:
a score calculation unit that inputs training data included in a training dataset to a trained neural network model, generates statistical information indicating an internal state of the trained neural network model for each piece of the training data, and calculates a score indicating a complexity of the training data based on the generated statistical information; and
a parameter determination unit that determines, based on the calculated score, a parameter indicating a structure of a neural network model.

Also, in order to achieve the example object described above, an information processing method that is performed by a computer according to an example aspect of the present disclosure includes:
inputting training data included in a training dataset to a trained neural network model, generating statistical information indicating an internal state of the trained neural network model for each piece of the training data, and calculating a score indicating a complexity of the training data based on the generated statistical information; and
determining, based on the calculated score, a parameter indicating a structure of the neural network model.

Furthermore, in order to achieve the example object described above, a computer-readable recording medium according to an example aspect of the present invention includes a program recorded on the computer-readable recording medium, the program including instructions that cause the computer to carry out:
inputting training data included in a training dataset to a trained neural network model, generating statistical information indicating an internal state of the trained neural network model for each piece of the training data, and calculating a score indicating a complexity of the training data based on the generated statistical information; and
determining, based on the calculated score, a parameter indicating a structure of the neural network model.

### Advantageous Effects of the Invention

According to the present disclosure, a parameter indicating a structure of a neural network that has high recognition accuracy and can execute recognition processing at high speed can be determined.

### BRIEF DESCRIPTION OF THE DRAWINGS

FIG. 1 is a diagram for describing an example of the information processing apparatus.

FIG. 2 is a diagram for describing an example of a system including the information processing apparatus.

FIG. 3 is a diagram for describing the internal state.

FIG. 4 is a diagram for describing an example of the global statistical information.

FIG. 5 is a diagram for describing an example of the score determination information.

FIG. 6 is a diagram for describing a method for determining the number of layers.

FIG. 7 is a diagram for describing a method for determining the number of channels.

FIG. 8 is a diagram for describing an example of the operations of the information processing apparatus.

FIG. 9 is a diagram for describing an example of a computer that realizes the information processing apparatus.

### EXAMPLE EMBODIMENT

In the following, an example embodiment will be described with reference to the drawings. Note that, in the drawings described in the following, the same reference symbol is provided to elements having the same function or corresponding functions, and repetitive description thereof may be omitted.

### Example Embodiment

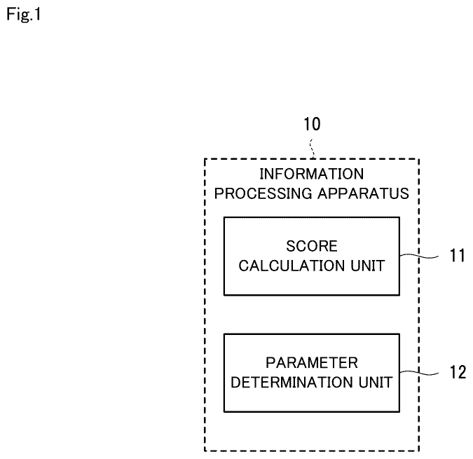

A configuration of an information processing apparatus in an example embodiment will be described with reference to FIG. 1. FIG. 1 is a diagram for describing an example of the information processing apparatus.

### [Apparatus Configuration]

An information processing apparatus 10 illustrated in FIG. 1 is an apparatus for efficiently searching for a structure of a neural network that has high recognition accuracy and can execute recognition processing at high speed. Furthermore, as illustrated in FIG. 1, the information processing apparatus 10 includes a score calculation unit 11 and a parameter determination unit 12.

The score calculation unit 11 inputs training data included in a training dataset to a trained neural network model, generates statistical information indicating an internal state (state of layers and channels) of the trained neural network model for each piece of the training data, and calculates a score indicating a complexity of the training data based on the generated statistical information.

The parameter determination unit 12 determines, based on the calculated score, a parameter indicating a structure of a neural network model that has higher recognition accuracy and can execute recognition processing at higher speed with respect to the training dataset than the trained neural network model.

By using a neural network model (second neural network model) obtained by training a neural network having the structure indicated by the above-described parameter using the training dataset, recognition accuracy becomes higher and recognition processing can be executed at higher speed compared to when the above-described trained neural network model (first neural network model) is used. For example, the parameter is the number of layers, the number of channels, etc.

As described above, in the example embodiment, a structure of a neural network that has high recognition accuracy and can execute recognition processing at high speed with respect to a training dataset can be determined without performing training in deep learning.

Specifically, by using a low-dimensional score indicating the complexity of training data, a parameter (number of layers, number of channels) indicating a structure of a neural network that has high recognition accuracy and can execute recognition processing at high speed with respect to the training data can be determined efficiently.

### [System Configuration]

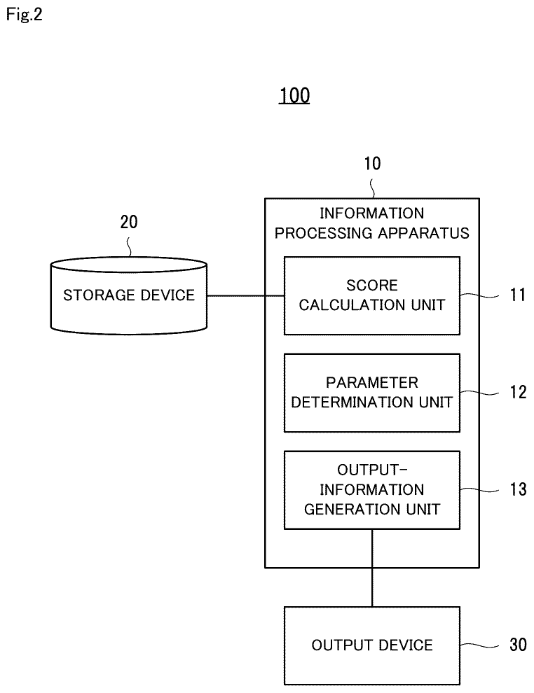

The configuration of the information processing apparatus 10 in the example embodiment will be described in detail with reference to FIG. 2. FIG. 2 is a diagram for describing an example of a system including the information processing apparatus.

As illustrated in FIG. 2, a system 100 includes the information processing apparatus 10, a storage device 20, and an output device 30. In the system 100, the information processing apparatus 10, the storage device 20, and the output device 30 are connected via a network.

For example, the information processing apparatus 10 is a central processing unit (CPU), a programmable device such as a field-programmable gate array (FPGA), a graphics processing unit (GPU), or a circuit, a server computer, a personal computer, a mobile terminal, or the like having one or more of a CPU, a programmable device, and a GPU installed therein.

The information processing apparatus 10 is a neural network structure determination apparatus for determining a parameter (number of layers, number of channels) for optimizing neural network structure.

The storage device 20 is a server computer, a circuit including a memory, or the like. For example, at least information such as a trained neural network model, a training dataset, and a parameter indicating a structure of a neural network is stored in the storage device 20. While the storage device 20 is provided outside the information processing apparatus 10 in the example in FIG. 2, the storage device 20 may be provided inside the information processing apparatus 10.

The output device 30 acquires the later-described output information, which has been converted into an outputtable format by an output-information generation unit 13, and outputs image(s), sound, etc., generated based on the output information. For example, the output device 30 is an image display device in which liquid crystal, organic electroluminescence (EL), or a cathode ray tube (CRT) is used, or the like. Furthermore, the image display device may include a sound output device such as a speaker or the like, etc. Note that the output device 30 may be a printing device such as a printer.

For example, the network is a conventional network that is constructed using a communication line such as the Internet, a Local Area Network (LAN), a dedicated line, a telephone line, an enterprise intranet, a mobile communication network, Bluetooth (registered trademark), or Wireless Fidelity (WiFi).

The information processing apparatus 10 in FIG. 2 includes the score calculation unit 11, the parameter determination unit 12, and an output-information generation unit 13.

The score calculation unit will be described in detail.

The score calculation unit 11 first inputs training data included in a training dataset to a trained neural network model, and generates statistical information indicating an internal state of the trained neural network model for each training dataset.

For example, the training dataset is a collection of image data, a collection of video data, a collection of vibration data, a collection of sound data, or the like.

The trained neural network model is a neural network model that has already been trained. Note that the trained neural network model may be implemented on the information processing apparatus 10, or may be implemented on an information processing apparatus other than the information processing apparatus 10.

For example, it is conceivable to use a neural network model such as M2Det or Residual Network (ResNet) as the trained neural network model.

In regard to M2Det, refer to the document “Qijie Zhao, et al., ‘M2Det: A Single-Shot Object Detector Based on Multi-Level Feature Pyramid Network’, pp. 9259-9266, vol. 33 No. 01: AAAI-19, [Submitted on 12 Nov. 2018 (v1), last revised 6 Jan. 2019 (this version, v3)]”.

In regard to ResNet, refer to the document “Kaiming He, et al., ‘Deep Residual Learning for Image Recognition’, [online], [Submitted on 10 Dec. 2015], [retrieved on 16 May 2022], Internet <URL: https://arxiv.org/pdf/1512.03385.pdf>”.

For example, the internal state can be indicated using pixel values of activation maps in deep learning, and statistical information such as the average and variance of the pixel values.

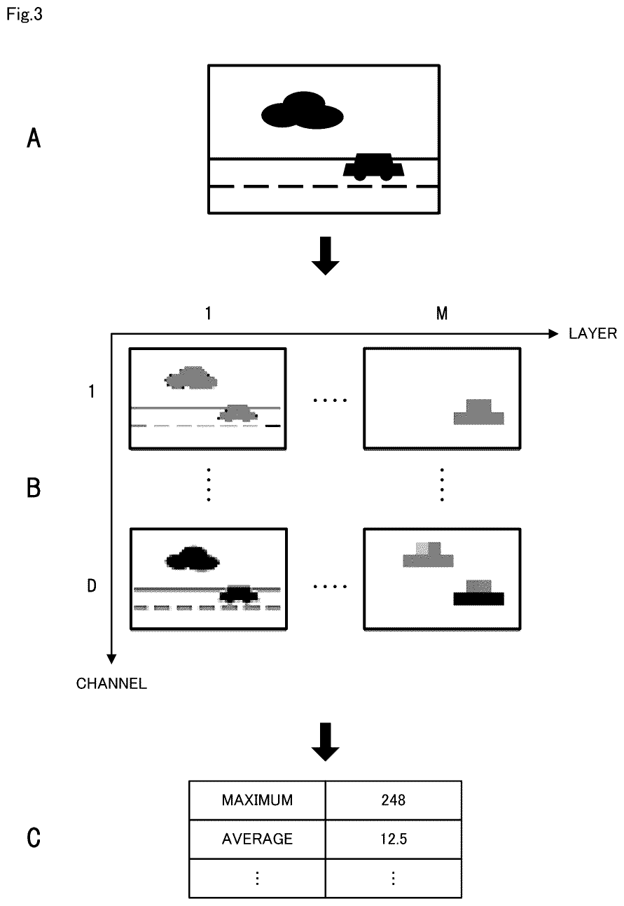

FIG. 3 is a diagram for describing the internal state. An example of training data is illustrated in A in FIG. 3. Examples of activation maps are illustrated in B in FIG. 3. An example of the internal state is illustrated in C in FIG. 3.

In A in FIG. 3, image data used as training data is illustrated; in the image data, a road, one vehicle traveling on the road, and one cloud floating in the sky are captured.

In the example in B in FIG. 3, activation maps of the trained neural network model obtained when the above-described image data is inputted to the trained neural network model to execute inference processing are illustrated.

In the activation maps illustrated in B in FIG. 3, the horizontal axis indicates layers, and the vertical axis indicates channels. The trained neural network model is formed from M layers. M is an integer of 2 or greater. Each layer is formed from D or less channels. D is an integer of 1 or greater.

Furthermore, in the activation maps illustrated in B in FIG. 3, for the sake of convenience, only the activation maps for channel 1 of layer 1, channel D of layer 1, channel 1 of layer M, and channel D of layer M are illustrated as examples.

In the example in C in FIG. 3, the maximum and average of all pixel values of activation maps of individual channels included in the trained neural network model are illustrated as the statistical information.

However, the statistical information is not limited to the above-described maximum and average of all pixel values, and, for example, the maximum and average of all pixel values of activation maps of each layer may be used. Alternatively, as the statistical information, the maximum and average of all pixel values of activation maps of each stage obtained by combining a plurality of layers may be used. Furthermore, the mode and/or the median may be used besides the maximum and average.

Alternatively, as the statistical information, the maximum and average of all pixel values of activation maps of all channels of some layers may be used. Alternatively, as the statistical information, the maximum and average of all pixel values of activation maps of some channels of some layers may be used.

Next, based on the statistical information calculated for each piece of training data, the score calculation unit 11 generates global statistical information corresponding to the training dataset.

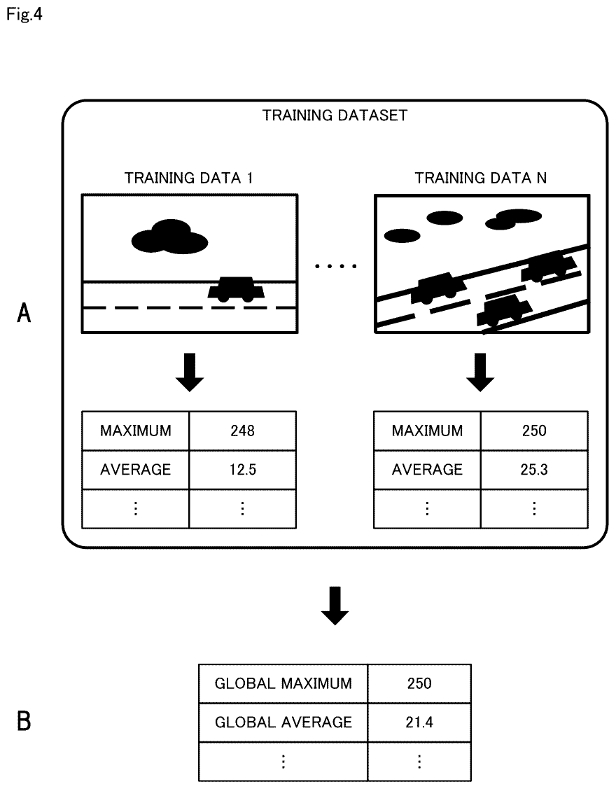

FIG. 4 is a diagram for describing an example of the global statistical information. In A in FIG. 4, pieces of statistical information indicating internal states corresponding to pieces of training data included in the training dataset are illustrated. In B in FIG. 4, global statistical information corresponding to the entire training dataset is calculated by taking the maximum and average of these pieces of statistical information.

In the example in B in FIG. 4, the global statistical information includes a global maximum and a global average. The global maximum is the maximum value among the maximums corresponding to the pieces of training data included in the training dataset. The global average is the average value of the averages corresponding to the pieces of training data included in the training dataset.

However, the global statistical information is not limited to the global maximum and global average. For example, in the global statistical information, the maximum value among the averages corresponding to the respective pieces of training data included in the training dataset may be adopted as the global maximum.

The global statistical information is information obtained by indicating, by numerical values, the degree of activation of the internal state when the pieces of training data included in the training dataset are input to the trained neural network model.

Next, the score calculation unit 11 first calculates a determination value based on the global statistical information and a preset mathematical operation (mathematical formula).

Next, the score calculation unit 11 refers to score determination information using the calculated determination value, and determines a score that corresponds to the determination value and indicates a complexity of the training data.

The score determination information is information in which scores and determination ranges for determining the score are associated with one another. The determination ranges are information indicating ranges to which determination values calculated based on statistical information indicating the internal state and the preset mathematical operation belong.

For example, the determination ranges are determined by means of experimentation, simulation, or the like. Note that, because determination values take different values depending on the type of mathematical operation and the type of statistical information used for calculation, the determination ranges need to be changed depending on the determination-value calculation method.

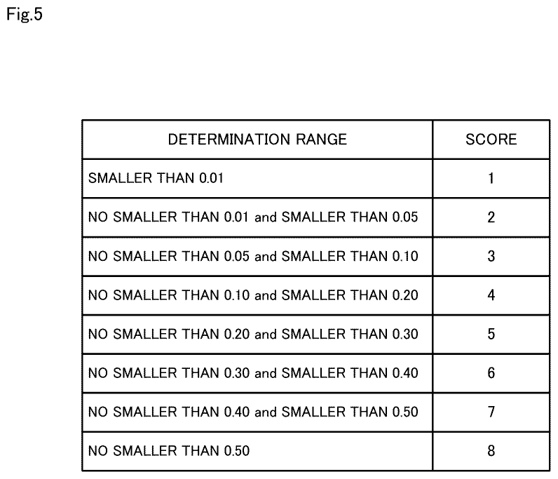

FIG. 5 is a diagram for describing an example of the score determination information. In the example in FIG. 5, the score calculation unit 11 first calculates a determination value (=global average/global maximum) by dividing the global average by the global maximum.

Next, in the example in FIG. 5, “1” is determined as the score if the determination value is smaller than 0.01, and “2” is determined as the complexity score if the determination value is no smaller than 0.01 and smaller than 0.05. In such a manner, a score is determined in accordance with the determination value.

Note that, in the example in C in FIG. 4, “3” is determined as the score because the determination value is 21.4/250=0.0856.

Note that the score need not be represented in one dimension, and may be represented in two or more dimensions. For example, the maximum and average may be calculated for each above-described stage obtained by combining a plurality of layers, and a score may be calculated for each stage, in which case representation by a four-dimensional value such as (3, 5, 4, 4) is performed.

The complexity is an index indicating how difficult it is to recognize the data in the training dataset. For example, the complexity would be higher for a training dataset including 80 types of objects than for a training dataset including only 1 type of object. Furthermore, in another example, the complexity would be higher for a training dataset including only images of pedestrians than for a training dataset including only images of apples. Thus, the complexity is defined using the global average, the global maximum, etc., for example.

The score is an index indicating complexity that is calculated using statistical information obtained upon input of each piece of training data. It is conceivable to represent the score using a low-dimensional discrete value.

For example, it is conceivable to represent the score using one-dimensional discrete values from 1 to 8 (level 1 to level 8). Alternatively, the score may be represented using one-dimensional continuous values from 1.0 to 100.0, for example. Furthermore, for example, the score may be represented using two-dimensional values such as (1, 3) and (5, 8).

Furthermore, instead of using the statistical information, the complexity of the training dataset may be determined by determining the redundancy of the trained neural network model based on the change in recognition accuracy when part of the trained neural network model is deleted.

The parameter determination unit will be described in detail.

The parameter determination unit 12 determines, based on the calculated score, a parameter indicating a structure of a neural network model. For example, the parameter is the number of layers, the number of channels, etc.

Specifically, the parameter determination unit 12 first acquires the score from the score calculation unit 11. Next, the parameter determination unit 12, based on the calculated score and a preset mathematical operation (mathematical formula), determines a parameter indicating a structure of a neural network model.

### (1) Explanation Regarding the Determination of Number of Layers

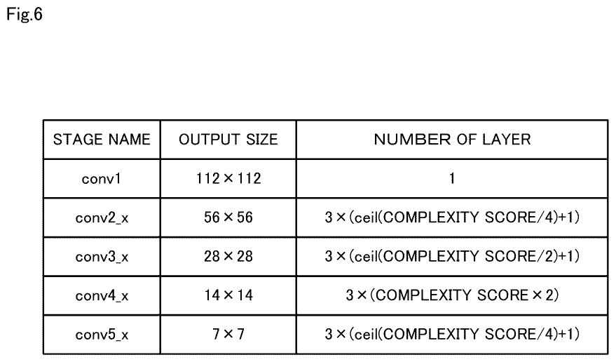

FIG. 6 is a diagram for describing a method for determining the number of layers. In the example in FIG. 6, a case will be described in which the number of layers of a neural network model such as ResNet is determined based on a score.

In the example in FIG. 6, the number of layers included in the individual stages when the output sizes of the stages are decreased in the order of 56×56, 28×28, 14×14, and 7×7 is determined.

Note that the number of layers is designated by designating the number of repetitions of a ResNet block that is formed from a 1×1 convolutional layer, a 3×3 convolutional layer, and a 1×1 convolutional layer, which are the basic ResNet blocks. That is, the number of layers is 2×3=6 if the number of repetitions of the ResNet block is 2, and the number of layers is 3×3=9 if the number of repetitions is 3.

In the example in FIG. 6, a table is shown in which a stage name “Stage name”, an output size “Output size”, and a number of layers “Number of layers” are associated with one another.

The parameter determination unit 12 sets the number of layers in the stage conv1 (output size: 112×112) as “1”.

The parameter determination unit 12 calculates the number of layers in the stage conv2_x (output size: 56×56) using Math. 1. Note that the function ceil( ) in the following formulas is a round-up function.

$$Number of layers in conv 2 \_x = 3 \times ( ceil ( score / 4 ) + 1 ) \qquad ( Math . 1 )$$

For example, if the score is 3, the number of layers in the stage conv2_x (output size 56×56) is calculated as 3×(ceil(3/4)+1)=6 layers.

The parameter determination unit 12 calculates the number of layers in the stage conv3_x (output size: 28×28) using Math. 2.

$$Number of layers in conv 3 \_x = 3 \times ( ceil ( score / 2 ) + 1 ) \qquad ( Math . 2 )$$

For example, if the score is 3, the number of layers in the stage conv3_x (output size 28×28) is calculated as 3×(ceil(3/2)+1)=9 layers.

The parameter determination unit 12 calculates the number of layers in the stage conv4_x (output size: 14×14) using Math. 3.

$$Number of layers in conv 4 \_x = 3 \times ( ceil ( score \times 2 ) \qquad ( Math . 3 )$$

For example, if the score is 3, the number of layers in the stage conv4_x (output size 14×14) is calculated as 3×(3×2)=18 layers.

The parameter determination unit 12 calculates the number of layers in the stage conv5_x (output size: 7×7) using Math. 4.

$$Number of layers in conv 5 \_x = 3 \times ( ceil ( score / 4 ) + 1 ) \qquad ( Math . 4 )$$

For example, if the score is 3, the number of layers in the stage conv5_x (output size 7×7) is calculated as 3×(ceil(3/4)+1)=6 layers.

Note that, for example, it is sufficient to set the coefficients in (Math. 1) to (Math. 4) based on the ratio between the number of layers in the individual stages in the neural network model, which is ResNet or the like. In the example in FIG. 6, the ratio conv2:conv3:conv4:conv5 between the number of layers is 1:2:4:1, and this is set based on the ratio 3:8:36:3 between the number of layers in ResNet 152, the ratio 3:4:23:3 between the number of layers in ResNet 101, and the ratio 3:4:6:3 between the number of layers in ResNet 50. However, there is no limitation to the example in FIG. 6, and an appropriate ratio may be adopted.

### (2) Explanation Regarding the Determination of Number of Channels

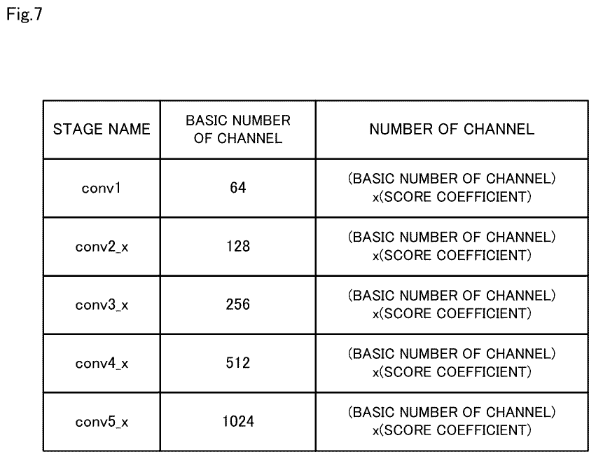

FIG. 7 is a diagram for describing a method for determining the number of channels. In the example in FIG. 7, a case will be described in which the number of channels in a neural network model such as ResNet is determined based on a score.

In the example in FIG. 7, the number of channels in each layer included in a stage is determined using a score and a preset linear correlation coefficient.

First, the parameter determination unit 12 calculates a score coefficient by multiplying a score by a predetermined correlation coefficient. Next, the parameter determination unit 12 calculates the number of channels in each layer included in a stage by multiplying a basic number of channels by the score coefficient.

The basic number of channels can be set based on the configuration of the neural network model, which is ResNet or the like. For example, the number of channels in the individual stages in ResNet is 64, 64, 128, 256, and 512, and it is sufficient that the basic number of channels be set so as to preserve, as much as possible, the ratio between the number of channels.

The correlation coefficient is set in order to multiply the basic number of channels, which is determined based on a known model, by a constant in accordance with the complexity. In the example in FIG. 6, the correlation coefficient is set to 0.25.

For example, the correlation coefficient can be determined by experimentation and simulation. Specifically, the number of channels that is sufficient and necessary to maximize recognition accuracy can be obtained by performing an experiment of: creating neural network models among which the number of channels is slightly changed; training the created neural network models using a given training dataset; and evaluating the recognition accuracy of the trained neural network models. The correlation coefficient can be obtained from the ratio between the complexity of the training dataset and the number of channels that maximizes the recognition accuracy when such an experiment is carried out.

For example, if the score is 3, the number of channels in each layer in the stage conv5_x is 1024×(3×0.25)=768 channels.

Note that, besides a linear correlation, a polynomial correlation, an exponential correlation, a logarithmic correlation, etc., may be used.

The output-information generation unit 13 generates output information to be output to the output device 30, such as the statistical information, the global statistical information, the score, and the parameter. Subsequently, the output-information generation unit 13 outputs the output information to the output device 30.

### [Apparatus Operations]

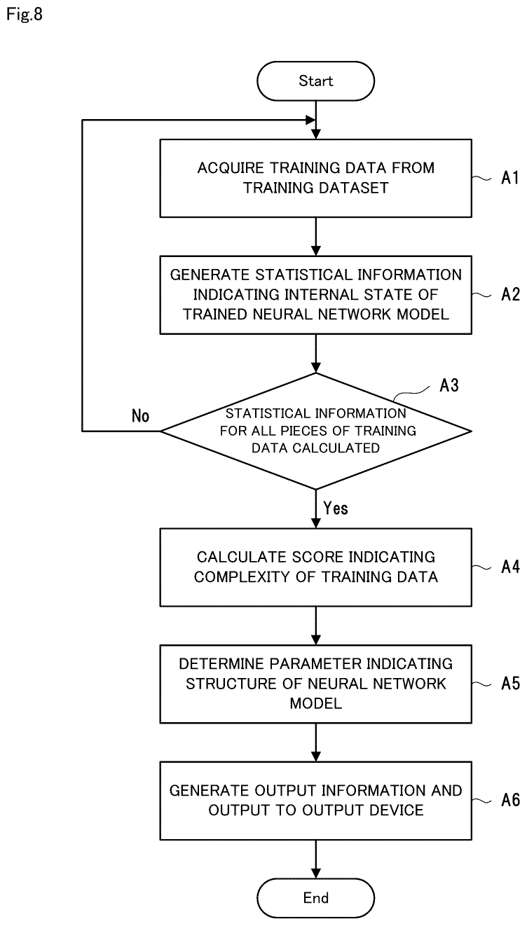

Next, operations of the information processing apparatus in the example embodiment will be described with reference to FIG. 8. FIG. 8 is a diagram for describing an example of the operations of the information processing apparatus. Drawings will be referred to as needed in the following description. Furthermore, in the example embodiment, a method for determining a parameter indicating a structure of a neural network is implemented by causing the information processing apparatus to operate. Accordingly, the following description of the operations performed by the information processing apparatus is substituted for the description of the method for determining a parameter indicating a structure of a neural network in the example embodiment.

As illustrated in FIG. 8, first, the score calculation unit 11 acquires training data from a training dataset stored in the storage device 20 and inputs the acquired training data to a trained neural network model (step A1).

Next, the score calculation unit 11 generates statistical information indicating an internal state (for example, the state of layers and channels, etc.) of the trained neural network model for each piece of training data (step A2). For example, the internal state indicates the state of layers, channels, etc.

Next, if the score calculation unit 11 has calculated statistical information for all pieces of the predetermined training data (step A3: Yes), the score calculation unit 11 executes the processing in step A5. If the score calculation unit 11 has not calculated statistical information for all pieces of the predetermined training data (step A3: No), the score calculation unit 11 executes the processing in step A1.

Next, the score calculation unit 11 calculates a score indicating a complexity of the training data based on the generated statistical information (step A4). Specifically, in step A4, the score calculation unit 11 first calculates a determination value based on the statistical information indicating the internal state and a preset mathematical operation. Next in step A4, the score calculation unit 11 refers to score determination information using the calculated determination value, and determines a score.

Next, the parameter determination unit 12 determines, based on the calculated score, a parameter indicating a structure of a neural network model that has high recognition accuracy and can execute recognition processing at high speed with respect to the training dataset (step A5). Specifically, in step A5, the parameter determination unit 12 determines a parameter such as the above-described (i) number of layers or (ii) number of channels.

Next, the output-information generation unit 13 generates output information to be output to the output device 30, such as the statistical information, the global statistical information, the score, the parameter, etc., and then outputs the output information to the output device 30 (step A6).

### Effects of Example Embodiment

In the example embodiment, a structure of a neural network that has high recognition accuracy and can execute recognition processing at high speed with respect to a training dataset can be determined without performing training in deep learning.

Specifically, by using a low-dimensional score indicating the complexity of training data, a parameter (number of layers, number of channels) indicating a structure of a neural network that has high recognition accuracy and can execute recognition processing at high speed with respect to the training data can be determined efficiently.

### [Program]

The program according to the example embodiment may be a program that causes a computer to execute steps A1 to A6 shown in FIG. 8. By installing this program in a computer and executing the program, the information processing apparatus and the information processing method according to the present example embodiment can be realized. Further, the processor of the computer performs processing to function as the score calculation unit 11, the parameter determination unit 12, and the output-information generation unit 13.

Also, the program according to the example embodiment may be executed by a computer system constructed by a plurality of computers. In this case, for example, each computer may function as any of the score calculation unit 11, the parameter determination unit 12, and the output-information generation unit 13.

### [Physical Configuration]

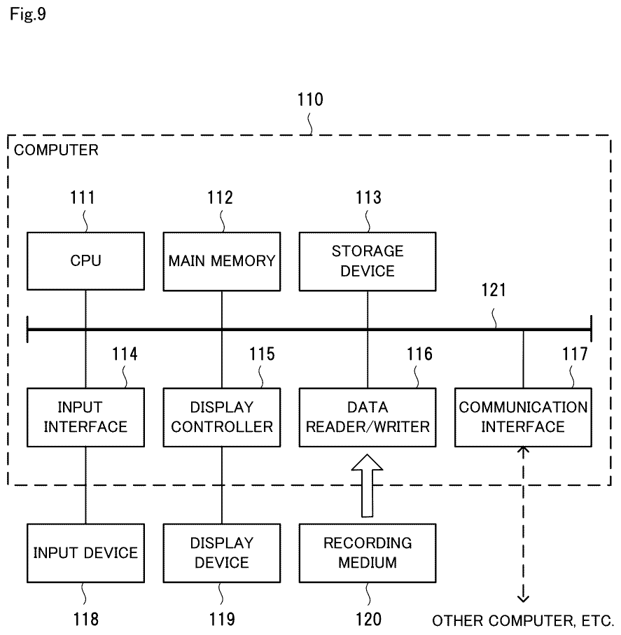

Here, a computer that realizes the causality search apparatus by executing the program according to the example embodiment will be described with reference to FIG. 9. FIG. 9 is a diagram for describing an example of a computer that realizes the information processing apparatus.

As shown in FIG. 9, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the information processing apparatus according to the example embodiment can also be realized by using hardware corresponding to each unit. Furthermore, a portion of the information processing apparatus may be realized by a program, and the remaining portion realized by hardware.

### [Supplementary Note]

Furthermore, the following supplementary notes are disclosed regarding the example embodiments described above. Some portion or all of the example embodiments described above can be realized according to (supplementary note 1) to (supplementary note 12) described below, but the below description does not limit the present invention.

### (Supplementary Note 1)

An information processing apparatus comprising:
a score calculation unit that inputs training data included in a training dataset to a trained neural network model, generates statistical information indicating an internal state of the trained neural network model for each piece of the training data, and calculates a score indicating a complexity of the training data based on the generated statistical information; and
a parameter determination unit that determines, based on the calculated score, a parameter indicating a structure of a neural network model.

### (Supplementary Note 2)

The information processing apparatus according to Supplementary note 1,
wherein the score calculation unit:
   based on the statistical information calculated for each piece of the training data, generates global statistical information corresponding to the training dataset; and
   calculates a determination value based on the global statistical information and a preset mathematical operation, and determines the score corresponding to the calculated determination value.

### (Supplementary Note 3)

The information processing apparatus according to Supplementary note 1 or 2,
wherein, based on the score, the parameter determination unit determines, as the parameter, the number of layers in the neural network model.

### (Supplementary Note 4)

The information processing apparatus according to Supplementary note 1 or 2,
wherein, based on the score, the parameter determination unit determines, as the parameter, the number of channels in the neural network model.

### (Supplementary Note 5)

An information processing method to be performed by a computer, comprising:
inputting training data included in a training dataset to a trained neural network model, generating statistical information indicating an internal state of the trained neural network model for each piece of the training data, and calculating a score indicating a complexity of the training data based on the generated statistical information; and
determining, based on the calculated score, a parameter indicating a structure of the neural network model.

### (Supplementary Note 6)

The information processing method according to Supplementary note 5,
wherein, based on the statistical information calculated for each piece of the training data, generating global statistical information corresponding to the training dataset; and
calculating a determination value based on the global statistical information and a preset mathematical operation, and determining the score corresponding to the calculated determination value.

### (Supplementary Note 7)

The information processing method according to Supplementary note 5 or 6,
wherein, determining the number of layers in the neural network model as the parameter based on the score.

### (Supplementary Note 8)

The information processing method according to Supplementary note 5 or 6,
wherein, determining the number of channels in the neural network model as the parameter based on the score.

### (Supplementary Note 9)

A computer-readable recording medium including a program recorded thereon, the program including instructions that cause a computer to carry out:
inputting training data included in a training dataset to a trained neural network model, generating statistical information indicating an internal state of the trained neural network model for each piece of the training data, and calculating a score indicating a complexity of the training data based on the generated statistical information; and
determining, based on the calculated score, a parameter indicating a structure of the neural network model.

### (Supplementary Note 10)

The computer readable recording medium according to Supplementary note 9,
wherein, based on the statistical information calculated for each piece of the training data, generating global statistical information corresponding to the training dataset; and
calculating a determination value based on the global statistical information and a preset mathematical operation, and determining the score corresponding to the calculated determination value.

### (Supplementary Note 11)

The computer readable recording medium according to Supplementary note 9 or 10,
wherein, determining the number of layers in the neural network model as the parameter based on the score.

### (Supplementary Note 12)

The computer readable recording medium according to Supplementary note 9 or 10,
wherein, determining the number of channels in the neural network model as the parameter based on the score.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention.

### INDUSTRIAL APPLICABILITY

According to the above disclosure, a parameter indicating a structure of a neural network that has high recognition accuracy and can execute recognition processing at high speed can be determined efficiently. Furthermore, the present invention is useful in fields in which it is necessary to optimize neural network model structure.

REFERENCE SIGNS LIST

| | |
|---|---|
| 10 | Information processing apparatus |
| 11 | Score calculation unit |
| 12 | Parameter determination unit |
| 13 | Output-information generation unit |
| 20 | Storage device |
| 30 | Output device |
| 100 | System |
| 110 | Computer |
| 111 | CPU |
| 112 | Main memory |
| 113 | Storage device |
| 114 | Input interface |
| 115 | Display controller |
| 116 | Data reader/writer |
| 117 | Communications interface |
| 118 | Input device |
| 119 | Display device |
| 120 | Recording medium |
| 121 | Bus |

What is claimed is:

1. An information processing apparatus comprising:
at least one memory storing instructions; and
at least one processor configured to execute the instructions to:
input training data included in a training dataset to a trained neural network model, generate statistical information indicating an internal state of the trained neural network model for each piece of the training data, and calculate score indicating a complexity of the training data based on the generated statistical information; and
determine, based on the calculated score, a parameter indicating a structure of a neural network model.

2. The information processing apparatus according to claim 1,
wherein the one or more processors further:
based on the statistical information calculated for each piece of the training data, generates global statistical information corresponding to the training dataset; and
calculates a determination value based on the global statistical information and a preset mathematical operation, and determines the score corresponding to the calculated determination value.

3. The information processing apparatus according to claim 1,
wherein the one or more processors further:
based on the score, determines, as the parameter, the number of layers in the neural network model.

4. The information processing apparatus according to claim 1,
wherein the one or more processors further:
based on the score, determines, as the parameter, the number of channels in the neural network model.

5. An information processing method to be performed by a computer, comprising:
inputting training data included in a training dataset to a trained neural network model, generating statistical information indicating an internal state of the trained neural network model for each piece of the training data, and calculating a score indicating a complexity of the training data based on the generated statistical information; and
determining, based on the calculated score, a parameter indicating a structure of a neural network model.

6. The information processing method according to claim 5,
wherein, based on the statistical information calculated for each piece of the training data, generating global statistical information corresponding to the training dataset; and
calculating a determination value based on the global statistical information and a preset mathematical operation, and determining the score corresponding to the calculated determination value.

7. The information processing method according to claim 5,
wherein, determining the number of layers in the neural network model as the parameter based on the score.

8. The information processing method according to claim 5,
wherein, determining the number of channels in the neural network model as the parameter based on the score.

9. A non-transitory computer-readable recording medium including a program recorded thereon, the program including instructions that cause a computer to carry out:
inputting training data included in a training dataset to a trained neural network model, generating statistical information indicating an internal state of the trained neural network model for each piece of the training data, and calculating a score indicating a complexity of the training data based on the generated statistical information; and
determining, based on the calculated score, a parameter indicating a structure of the neural network model.

10. The non-transitory computer readable recording medium according to claim 9,
wherein, based on the statistical information calculated for each piece of the training data, generating global statistical information corresponding to the training dataset; and
calculating a determination value based on the global statistical information and a preset mathematical operation, and determining the score corresponding to the calculated determination value.

11. The non-transitory computer readable recording medium according to claim 9,
wherein, determining the number of layers in the neural network model as the parameter based on the score.

12. The non-transitory computer readable recording medium according to claim 9,
wherein, determining the number of channels in the neural network model as the parameter based on the score.
